(19) United States
(12) Patent Application Publication
(10) Pub. No.: US 2015/0314592 A1
(43) Pub. Date: Nov. 5, 2015

(54) CONTROL DEVICE FOR INKJET HEAD AND INKJET RECORDING DEVICE

(71) Applicant: KONICA MINOLTA, INC., Chiyoda-ku, Tokyo (JP)

(72) Inventors: Shingo TSUBOTANI, Kunitachi-shi, Tokyo (JP); Akira TAKEYA, Hachioji-shi, Tokyo (JP)

(21) Appl. No.: 14/654,669

(22) PCT Filed: Dec. 12, 2013
(86) PCT No.: PCT/JP2013/083312

§ 371 Date: Jun. 22, 2015

(30) Foreign Application Priority Data
Dec. 21, 2012 (JP) 2012-278784

(51) Int. Cl. B41J 2/045

(52) U.S. Cl. CPC B41J 2/0454

(57) ABSTRACT

According to the present invention, the temperature of a head unit is more reliably controlled. A control device for inkjet head, which controls the temperature of a head unit in an inkjet head that is provided with the head unit for ejecting an ink and a heating unit for heating the ink within the head unit. This control device for inkjet head is provided with: a first control unit which controls the action of the heating unit so that the temperature of the head unit is at a first temperature; and a second control unit which stops the action of the heating unit in cases where the temperature of the head unit reaches a second temperature or higher, said second temperature being higher than the first temperature.

### TECHNICAL FIELD

The present invention relates to a control device for an inkjet head and an inkjet recording device.

### BACKGROUND ART

A head unit to eject ink, which is included in an inkjet head of an inkjet recording device, rises in temperature by being heated by a heating unit, such as a heater, to heat the ink to be ejected.

When the temperature of the head unit rises too much, the heat sometimes damages the head unit and may also cause various problems. For example, the heat from the head unit may damage parts, e.g., an IC chip, disposed near the head unit in the inkjet head. To address such a problem, an inkjet recording device is known having an operation control routine for an inkjet head, the operation control routine including a command to stop the operation of the inkjet head when the temperature is at or higher than a predetermined temperature (for example, Patent Literature 1).

### PRIOR ART LITERATURES

### Patent Literatures

### Patent Literature 1: Japanese Unexamined Patent Application Publication No. 8-39883

### DISCLOSURE OF INVENTION

### Problems to be Solved by the Invention

Unfortunately, the temperature control in such a conventional inkjet recording device has a risk that a heating unit loses control and cannot stop the temperature rise of a head unit if some trouble arises in the control routine, such as a freeze of a control unit that executes the operation control routine of an inkjet head.

An object of the present invention is to provide a control device for an inkjet head and an inkjet recording device that achieve reliable control of the temperature of a head unit.

### Means for Solving Problems

The invention recited in claim 1 is a control device for an inkjet head, the inkjet head including a head unit to eject ink and a heating unit to heat the ink in the head unit, the control device, which controls a temperature of the head unit, including: a first control unit which controls an operation of the heating unit for the temperature of the head unit to be a first temperature; and a second control unit which stops the operation of the heating unit when the temperature of the head unit is equal to or higher than a second temperature which is higher than the first temperature.

The invention recited in claim 2 is the control device for the inkjet head according to claim 1, further including a generation unit which generates a voltage according to the temperature of the head unit, wherein the second control unit stops the operation of the heating unit when the temperature of the head unit is determined to be equal to or higher than the second temperature on the basis of the voltage obtained from the generation unit and a reference voltage corresponding to the second temperature.

The invention recited in claim 3 is the control device for the inkjet head according to claim 1 or 2, wherein the second control unit cancels the stop of the operation of the heating unit when the temperature of the head unit becomes lower than the second temperature after the second control unit stops the operation of the heating unit.

The invention recited in claim 4 is the control device for the inkjet head according to any one of claims 1 to 3, further including a switching unit which is disposed on a line to supply electrical power to the heating unit and switches between connection and disconnection of the line, wherein the second control unit stops the operation of the heating unit by controlling the switching unit to disconnect the line.

An inkjet recording device according to the invention recited in claim 5 is includes: the inkjet head including the head unit having nozzles to eject the ink, and the heating unit to heat the ink in the head unit; and the control device for the inkjet head according to any one of claims 1 to 4.

### Effects of the Invention

The present invention achieves reliable control of the temperature of a head unit.

### BRIEF DESCRIPTION OF DRAWINGS

FIG. 1 is a block diagram showing the configuration of an inkjet recording device according to an embodiment of the present invention;

FIG. 2 is a graph showing an example of the relationship between the voltage of a generation unit, a reference voltage, the temperature of a head unit, and the control for a heating unit by a second control unit; and

FIG. 3 is a graph showing another example of the relationship between the voltage of a generation unit, a reference voltage, the temperature of a head unit, and the control for a heating unit by a second control unit.

### BEST MODE TO CARRY OUT THE INVENTION

An Embodiment of the present invention will now be described with reference to the drawings. The following embodiment includes various limitations which are technically preferable to carry out the present invention. The scope of the invention, however, should not be limited to the embodiment and the example shown in the drawings.

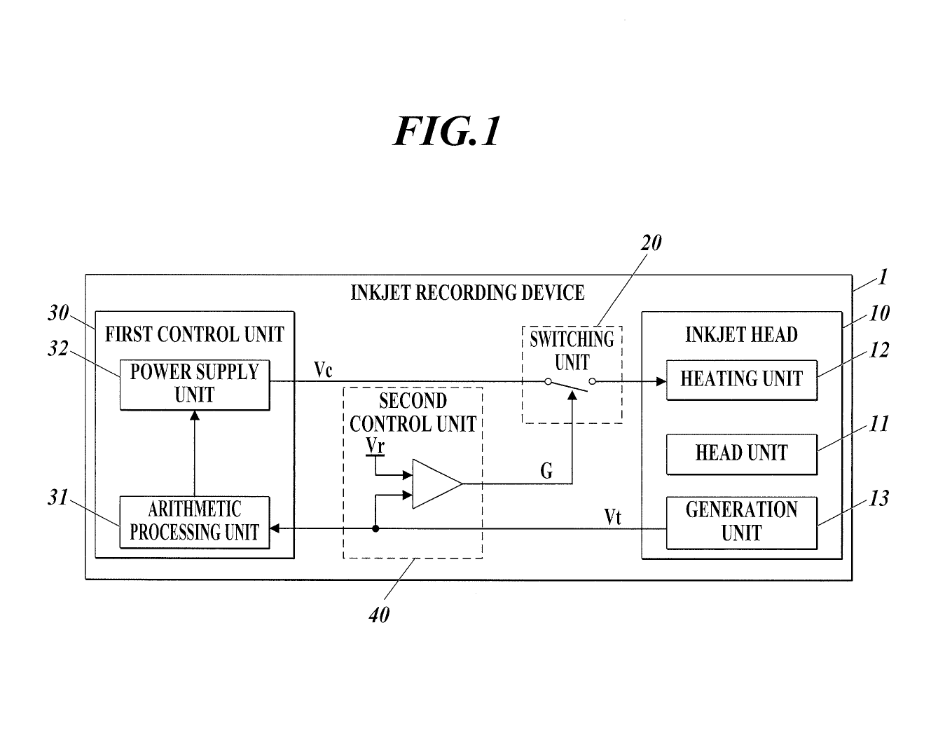

FIG. 1 is a block diagram showing the configuration of an inkjet recording device 1 according to an embodiment of the present invention. FIG. 1 shows only the configuration related to the temperature control for a head unit 11 included in the control for an inkjet head 10, and the other configuration is not shown.

The inkjet recording device 1 includes the inkjet head 10, a switching unit 20, a first control unit 30, a second control unit 40, and lines connecting these units etc.

The inkjet head 10 includes the head unit 11, a heating unit 12, and a generation unit 13 etc.

The head unit 11 ejects ink.

Specifically, the head unit 11 is constituted of an inkjet head chip having nozzles to eject ink, for example.

The head unit 11 also includes, for example, a manifold (now shown) to lead the ink supplied from an ink supply system to the inkjet head chip. The inkjet head chip ejects the ink, led through the manifold, onto a recording medium, such as a sheet of paper, under the control of the first control unit 30.

The heating unit 12 heats ink in the head unit 11.

Specifically, the heating unit 12 is constituted of a heating wire disposed, for example, along a lateral surface of the head unit 11 to generate heat in response to an applied current. The heating unit 12 generates heat in accordance with an applied current to heat the head unit 11 and thereby heats the ink in the head unit 11 under the control of the first and second control units 30 and 40.

The position of the heating unit 12 relative to the head unit can be changed freely. For example, the heating unit 12 may be disposed along a lateral surface of the manifold so as to heat the ink in the inkjet head chip through the manifold or may directly heat the inkjet head chip to heat the ink in the inkjet head chip.

The generation unit 13 generates a voltage Vt according to the temperature of the head unit 11.

Specifically, for example, the generation unit 13 is constituted of a thermistor, whose electrical resistance value changes depending on temperature. The generation unit 13 is in contact with a part, which is not directly heated by the heating unit 12, of the outer periphery of the head unit 11, for example. The generation unit 13 thus changes in temperature according to the temperature change of the head unit 11. Since the electrical resistance value of the generation unit 13 changes depending on temperature, the voltage Vt, which is generated with a constant current flowing at the generation unit 13, changes in response to a change of the electrical resistance value of the generation unit 13 according to a temperature change of the generation unit 13, i.e., according to a temperature change of the head unit 11. The voltage Vt generated from the generation unit 13 is sensed by the first and second control units 30 and 40.

The thermistor serving as the generation unit 13 in this embodiment is, for example, a negative temperature coefficient (NTC) thermistor having a lower electrical resistance value with a higher temperature. As the temperature of the head unit 11 is higher, the thermistor has a higher temperature and a lower electrical resistance value and thus the voltage Vt of the generation unit 13 is lower.

In addition to the above described units, the inkjet head 10 includes a board having wiring and circuits etc. (not shown) disposed thereon to drive the head unit 11 under the control of the first control unit 30, a frame (not shown) to support the board and units such as the head unit 11.

The switching unit 20 is disposed on a line to supply electrical power to the heating unit 12 and switches between connection and disconnection of the line.

Specifically, the switching unit 20 switches between connection and disconnection of the line depending on the presence or absence of a signal G (described later), for example. The switching unit 20 is disposed on the line connecting the power supply unit 32 and the heating unit 12.

The first control unit 30 performs control related to ink ejection from the inkjet head 10. Specifically, based on original data of an image to be formed on a recording medium, the first control unit 30 performs processing for controlling operations of the units related to image formation, such as the head unit 11 of the inkjet head 10, an ink supply system (not shown), a carriage (not shown), and a recording medium conveying unit (not shown).

The first control unit 30 controls the operation of the heating unit 12 for the head unit 11 to be at a first temperature T1.

Specifically, the first control unit 30 includes, for example, an arithmetic processing unit 31 having a CPU, a RAM, and a ROM etc.; and the power supply unit 32 to operate under the control of the arithmetic processing unit 31. The CPU of the arithmetic processing unit 31 reads programs and data related to the control for the heating unit 12 from the ROM, execute them, and controls electrical power supply from the power supply unit 32 to the heating unit 12 according to the processing. The first control unit 30 thereby controls the operation of the heating unit 12.

More specifically, the arithmetic processing unit 31 of the first control unit 30 obtains the temperature of the head unit 11 based on the voltage Vt of the generation unit 13. The arithmetic processing unit 31 controls the power supply unit 32 to supply electrical power to the heating unit 12 if the head unit 11 is below the first temperature T1, and controls the power supply unit 32 to stop the electrical power supply to the heating unit 12 if the head unit 11 is at the first temperature T1 or above. The first control unit 30 operates on the condition that the line with the switching unit 20 is connected.

The first temperature T1 is set to any temperature, for example, in accordance with the design related to the temperature of ink to be ejected from the head unit 11.

The ink used in this embodiment has optimal fluidity to be ejected at the first temperature T1. The first temperature T1 in this embodiment is, for example, 60° C. or 85° C., but the first temperature T1 is not limited to these.

The arithmetic processing unit 31 according to this embodiment controls the operation of the power supply unit 32 through proportional-integral-derivative (PID) control according to the relationship between the first temperature T1, which is a target temperature of the head unit 11, and the temperature of the head unit 11 determined based on the voltage Vt.

The power supply unit 32 changes an output voltage Vc through pulse width modulation (PWM) to control whether to supply electrical power and the level of the supply.

Such specific operations of the arithmetic processing unit 31 and the power supply unit 32 are illustrative only, but the operations are not limited to those. Any mechanism may be used that can control the operation of the heating unit 12 for the head unit 11 to be at the first temperature T1.

When the temperature of the head unit 11 is at or above a second temperature T2, which is higher than the first temperature T1, the second control unit 40 stops the operation of the heating unit 12.

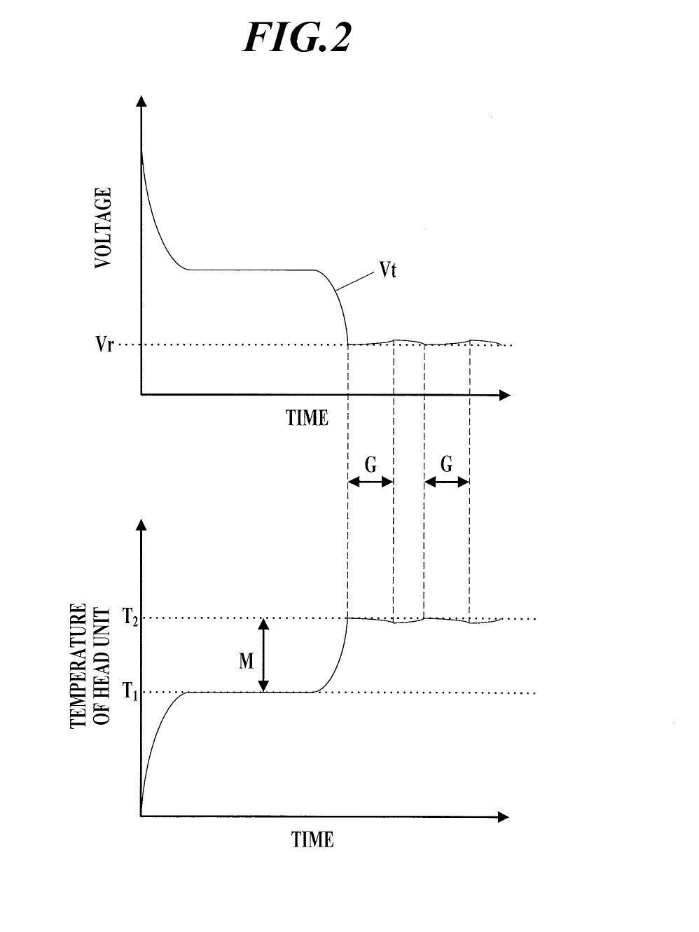

Specifically, for example, the second control unit 40 is constituted of a comparator to make an output in accordance with the magnitude relation of the two voltages, i.e., the voltage Vt of the generation unit 13 and a predetermined reference voltage Vr. As shown in FIG. 2, when the voltage Vt is equal to or lower than the reference voltage Vr, the second control unit 40 outputs a signal G to operate the switching unit 20 so as to disconnect the line with the switching unit 20. The switching unit 20 operates so as to disconnect the line in response to the signal G.

The reference voltage Vr corresponds to the second temperature T2, which is higher than the first temperature T1. The voltage Vt of the generation unit 13 is lower as the temperature of the head unit 11 is higher, as described above. Accordingly, the voltage Vt is higher than the reference voltage Vr when the temperature of the head unit 11 is lower than the second temperature T2, and the voltage Vt is equal to or lower than the reference voltage Vr when the temperature of the head unit 11 is equal to or higher than the second temperature T2. That is, the second control unit 40 disconnects the line with the switching unit 20 when the voltage Vt is equal to or lower than the reference voltage Vr as described above, thereby achieving disconnection of the line when the temperature of the head unit 11 is equal to or higher than the second temperature T2. The reference voltage Vr is, for example, a constant voltage output from a circuit, such as a regulator, but is not limited to this. The reference voltage Vr may be any other voltage obtained from a configuration for generating a voltage that would serve as the reference voltage Vr.

As described above, when the temperature of the head unit 11 is determined to be equal to or higher than the second temperature T2 on the basis of the voltage Vt obtained from the generation unit 13 and the reference voltage Vr corresponding to the second temperature T2, the second control unit 40 controls the switching unit 20 to disconnect the line to stop the operation of the heating unit 12.

The second control unit operating as described above disconnects the line with the switching unit 20 to stop the electrical power supply from the power supply unit 32 to the heating unit 12 when the temperature of the head unit 11 is equal to or higher than the second temperature T2, even if the electrical power supply to the heating unit 12 continues for some reason in spite of the temperature of the head unit 11 being equal to or higher than the first temperature T1. In other words, the operation of the heating unit 12 stops regardless of the control of the first control unit 30 if the temperature of the head unit 11 is equal to or higher than the second temperature T2. The second control unit 40 thus stops the operation of the heating unit 12 preferentially over the operational control for the heating unit 12 performed by the first control unit 30 when the temperature of the head unit 11 is equal to or higher than the second temperature T2.

The second temperature T2 may be set to any temperature, for example, in accordance with the upper temperature limit tolerated by the head unit 11 and the components around the head unit 11.

Specifically, a temperature over 100° C. increases the risk of damage to the circuits, such as IC chips, provided in the inkjet head 10 including the inkjet head chip constituting the head unit 11 of this embodiment. Accordingly, the second temperature T2 may be set to 100° C. so that the operation of the heating unit 12 is stopped when the temperature of the head unit 11 reaches 100° C. This can surely prevent the head unit 11 from being heated to over 100° C., leading to reliable prevention of damage of the head unit 11 due to overheating.

When the temperature of the head unit 11 becomes lower than the second temperature T2 after the second temperature T2 stops the operation of the heating unit 12, the second control unit 40 cancels the stop of the operation of the heating unit 12.

Specifically, since the generation unit 13 generates a voltage Vt according to the temperature of the head unit 11, a temperature decrease of the head unit 11 after the stop of the operation of the heating unit 12 causes a change in voltage Vt. In this embodiment, a temperature decrease of the head unit 11 causes an increase of the voltage Vt. The increase of the voltage Vt to over the reference voltage Vr causes the second control unit 40 to stop outputting the signal G. In this case, the switching unit 20 operates so as to connect the line in response to the disappearance of the signal G. The stop of the operation of the heating unit 12 by the second control unit 40 is thereby cancelled.

In FIG. 2 etc., the output of the signal G stops when the voltage Vt clearly exceeds the reference voltage Vr for simplicity, but in fact the signal G output is controlled in accordance with the result of more rigorous comparison between the voltage Vt and the reference voltage Vr.

Thus the generation unit 13, the switching unit 20, the first control unit 30, and the second control unit 40 in this embodiment work in cooperation with one another to serve as a control device for the inkjet head 10 to control the temperature of the head unit 11.

When the second control unit 40 stops the operation of the heating unit 12, the status of the inkjet recording device 1, such as the status of the control of the first control unit 30, is preferably checked. So, the inkjet recording device 1 may include a configuration to notify a user that the second control unit 40 has stopped the operation of the heating unit 12. Such notification allows the user to easily know that the second control unit 40 has stopped the operation of the heating unit 12. In other words, the inkjet recording device 1 can prompt the user to check the status of the inkjet recording device 1.

Specific examples of the configuration for the notification include, but not be limited to, a display unit to display the information that the second control unit 40 has stopped the operation of the heating unit 12, a light-emitting unit to light up to notify the information, and a voice announcement unit to give the notification through a predetermined announcement.

As described above, the inkjet recording device 1 of this embodiment includes the second control unit 40 which stops the operation of the heating unit 12 when the temperature of the head unit 11 is equal to or higher than the second temperature T2 which is higher than the first temperature T1. Such a configuration prevents the head unit 11 from continuing to be heated to over the second temperature T2 even if the temperature of the head unit 11 becomes higher than the first temperature T1. The temperature of the head unit 11 can thus be reliably controlled.

For example, in the case in which an ink whose temperature for ink ejection is to be 85° C. is used, the ink in the head unit 11 is heated up to 85° C. under the control of the first control unit 30. There is an increasing risk of damage of the head unit 11 at 100° C., but the temperature of 85° C. has a smaller margin M before reaching 100° C. than in the case of a lower temperature (e.g., 60° C.) for ink ejection. When the head unit 11 continues to be heated to over an assumed ink temperature for some reason, the temperature of the head unit 11 easily reaches 100° C. Thus there is a need for a reliable system to control the temperature of the head unit 11 not to become higher than 100° C. In the present embodiment, the second control unit 40 controls the temperature of the head unit 11 not to be higher than 100° C., and thereby the damage of the head unit 11 due to overheating can be surely prevented.

In this way, the inkjet recording device 1 according to this embodiment includes the second control unit 40 and can reliably control the temperature of the head unit 11 even under the environment where a strict temperature control is required. The second control unit 40 operates in accordance with a predetermined second temperature T2 regardless of how large the margin M is, and thereby can reliably control the temperature of the head unit 11 regardless of the design related to ink.

Further, when the temperature of the head unit 11 is determined to be equal to or higher than the second temperature T2 on the basis of the voltage Vt obtained from the generation unit 13 and the reference voltage Vr corresponding to the second temperature T2, the operation of the heating unit 12 is stopped. In other words, the reference voltage Vr determines the temperature at which the second control unit 40 stops the heating unit 12. That is, the head unit 11 can be prevented from being damaged due to overheating merely by determining the reference voltage Vr in accordance with the upper temperature limit tolerated by the head unit 11. This achieves easy temperature control of the head unit 11.

Further, since the second control unit 40 is a circuit to control the operation of the heating unit 12 in accordance with the result of comparison of voltages, there is little risk of overheating of the head unit 11 due to a bug or freeze of a program which would be caused in an operation control for the heating unit 12 through information processing. This achieves more reliable operation control.

Further, when the temperature of the head unit 11 becomes lower than the second temperature T2 after the operation of the heating unit 12 is stopped, the stop of the operation of the heating unit 12 by the second control unit 40 is cancelled. Such a configuration allows the inkjet recording device 1 to continue operating on the condition that the head unit 11 is not heated to over the second temperature T2. This allows the inkjet recording device 1 to continue operating while the temperature of the head unit 11 is controlled not to exceed the second temperature T2 and thus enhances flexibility in operation of the inkjet recording device 1 in response to, for example, a demand for continuing the operation of the inkjet recording device 1 for some reason after the temperature of the head unit 11 exceeds the first temperature T1.

Further, since the operation of the heating unit 12 stops when the switching unit 20 is controlled to disconnect the line, the temperature of the head unit 11 can be reliably controlled with a simple structure.

The embodiment of the present invention disclosed here should not be construed as limiting the present invention but should be construed as illustrative in all respects. The scope of the present invention is not defined by the description given above but is defined by the claims and is intended to include all the modifications within the meaning and scope of the claims and their equivalents.

For example, although an NTC thermistor is used as an example of the generation unit 13 in the above-described embodiment, the generation unit 13 is not limited to it. For example, a critical temperature resistor (CTR) thermistor may alternatively be used as the generation unit 13.

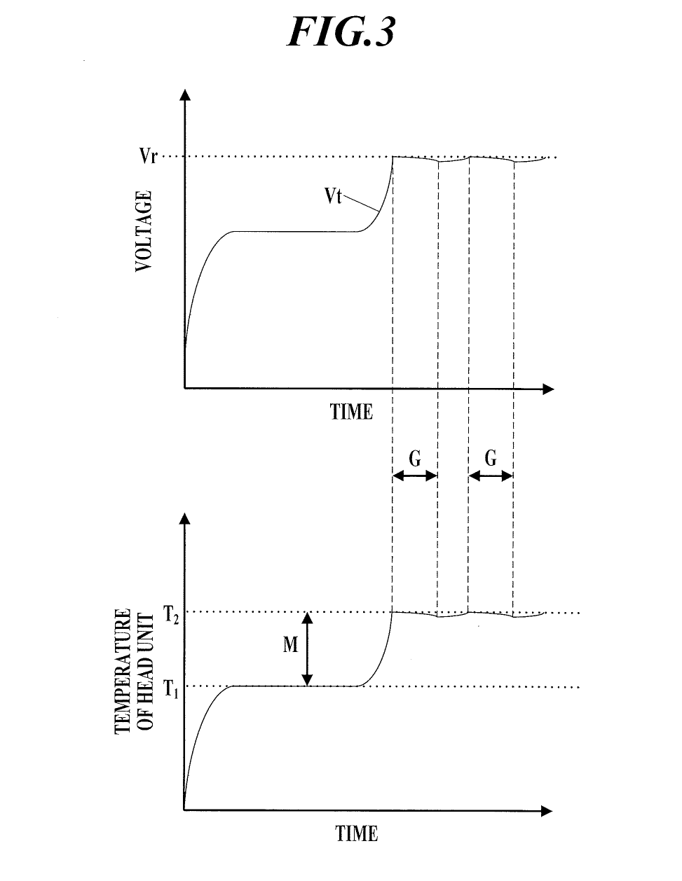

If a positive temperature coefficient (PTC) thermistor, having a higher electrical resistance value at a higher temperature, is used as the generation unit 13, the voltage Vt of the generation unit 13 is higher with a higher temperature of the head unit 11, contrary to the case of the NTC thermistor in the above-described embodiment. Accordingly, as shown in FIG. 3, the voltage Vt is lower than the reference voltage Vr when the temperature of the head unit 11 is lower than the second temperature T2, whereas the voltage Vt is equal to or higher than the reference voltage Vr when the temperature of the head unit 11 is equal to or higher than the second temperature T2. So, in the case of a PTC thermistor used as the generation unit 13, the second control unit 40 outputs the signal G to operate the switching unit 20 so as to disconnect the line with the switching unit 20 when the voltage Vt is equal to or higher than the reference voltage Vr.

A temperature of “lower than the second temperature T2”, which is a trigger for the second control unit 40 cancelling the stop of the operation of the heating unit 12 in the above-described embodiment, may be changed as appropriate. For example, a variable regulator may be used to change the reference voltage Vr depending on various conditions, such as the temperature of the head unit 11, and the reference voltage Vr may be changed depending on presence or absence of the signal G. Thereby the temperature, at which the second control unit 40 stops the operation of the heating unit 12, is made different from the temperature, at which the second control unit 40 cancels the stop of the operation of the heating unit 12.

Specifically, the temperature, at which the second control unit 40 cancels the stop of the operation of the heating unit 12, may be set to be lower than the temperature, at which the second control unit 40 stops the operation of the heating unit 12. Such a configuration can lead the head unit 11 to cool naturally, surely enabling protection of the head unit 11 from damage due to overheating. In this case, the temperature, at which the stop of the operation of the heating unit 12 is cancelled, is set to be equal to or higher than the first temperature T1, which is a reference temperature for the first control unit 30 to control the heating unit 12. The temperature of the head unit 11 can thereby be kept at equal to or higher than an assumed temperature under the control of the first control unit 30. This can surely control temperature of the head unit 11 without decreasing the temperature of the head unit 11 too much.

In the above-described embodiment, the power supply unit 32 is disposed in the first control unit 30 as an example, but the configuration is not limited to this. For example, a power supply device, which is connected to the heating unit 12, may be disposed outside of the first control unit 30. In such a case, the first control unit 30 controls the operation of the heating unit 12 by controlling the operation of the power supply device.

Further, in the above-described embodiment, explanations are given with reference to FIG. 1 where the number of each of the inkjet head 10, the switching unit 20, the first control unit 30, and the second control unit 40 etc. is only one. FIG. 1, however, is merely an example but is not limitative. The inkjet recording device 1 may include a plurality of inkjet heads 10. In such a case, the switching unit 20 and the second control unit 40 are individually provided for each of the inkjet heads 10. On the other hand, the first control unit 30 does not necessarily have to be provided individually for each of the inkjet heads 10 to individually control the operation of the heating unit 12 of each of the inkjet heads 10. In this case, a smaller number of the first control unit(s) 30 than the number of inkjet heads 10 individually control (s) the operation of the heating unit 12 of each of the inkjet heads 10, and each of the second control units 40 controls the operation of the heating unit 12 of a corresponding inkjet head 10.

Further, in the above-described embodiment, the first control unit 30 performs both the control for image formation by the inkjet recording device 1 and the control for the operation of the heating unit 12. The configuration, however, is not limited to this example. Alternatively, the first control unit 30 may perform only the control for the operation of the heating unit 12 or may additionally perform other processing.

### INDUSTRIAL APPLICABILITY

The present invention relates to a control device for an inkjet head and an inkjet recording device.

### REFERENCE NUMERALS

1 inkjet recording device
10 inkjet head
11 head unit
12 heating unit
13 generation unit
20 switching unit
30 first control unit
31 arithmetic processing unit
32 power supply unit
40 second control unit

1. A control device for an inkjet head, the inkjet head including a head unit to eject ink and a heating unit to heat the ink in the head unit, the control device, which controls a temperature of the head unit, comprising:
a first control unit which controls an operation of the heating unit for the temperature of the head unit to be a first temperature; and
a second control unit which stops the operation of the heating unit when the temperature of the head unit is equal to or higher than a second temperature which is higher than the first temperature.

2. The control device for the inkjet head according to claim 1, further comprising a generation unit which generates a voltage according to the temperature of the head unit, wherein
the second control unit stops the operation of the heating unit when the temperature of the head unit is determined to be equal to or higher than the second temperature on the basis of the voltage obtained from the generation unit and a reference voltage corresponding to the second temperature.

3. The control device for the inkjet head according to claim 1, wherein the second control unit cancels the stop of the operation of the heating unit when the temperature of the head unit becomes lower than the second temperature after the second control unit stops the operation of the heating unit.

4. The control device for the inkjet head according to claim 1, further comprising a switching unit which is disposed on a line to supply electrical power to the heating unit and switches between connection and disconnection of the line, wherein
the second control unit stops the operation of the heating unit by controlling the switching unit to disconnect the line.

5. An inkjet recording device comprising:
the inkjet head comprising the head unit having nozzles to eject the ink, and the heating unit to heat the ink in the head unit; and
the control device for the inkjet head according to claim 1.
